(19) United States
(12) Patent Application Publication
(10) Pub. No.: US 2020/0400963 A1
(43) Pub. Date: Dec. 24, 2020

(54) CUSHION ASSEMBLY FOR HEAD-MOUNTED DEVICE AND MANUFACTURING METHOD THEREOF

(71) Applicant: Regina Miracle International (Group) Limited, Kwai Chung, Hong Kong (CN)

(72) Inventor: Zhenqiang LIU, Kwai Chung, Hong Kong (CN)

(21) Appl. No.: 16/975,053

(22) PCT Filed: Feb. 22, 2018
(86) PCT No.: PCT/CN2018/076972

§ 371 Date: Aug. 21, 2020

(51) Int. Cl. G02B 27/01; B29C 65/08; B29C 45/14; B32B 27/12; B32B 27/06

(52) U.S. Cl. CPC G02B 27/0176; B29C 65/08; B29C 45/14467; B29C 45/14795; B29L 2031/58; B32B 27/12; B32B 27/065; G02B 2027/0192; B29C 45/14811

(57) ABSTRACT

A method of manufacturing a cushion assembly for a head-mounted device is provided. The method includes molding a foam material to provide a first panel with a first layer having a three-dimensional configuration defined therein. The method further includes arranging a second panel and a third panel with respect to the first panel such that the first panel is disposed between the second panel and the third panel. The method further includes molding the first panel, the second panel and the panel layer together to form a single piece laminate. The method further includes trimming the single piece laminate to form the cushion assembly adapted to conform to a face of a wearer of the head-mounted device.

### FIELD OF THE PRESENT DISCLOSURE

The present disclosure generally relates to a head-mounted device, and more particularly to a cushion assembly, for the head-mounted device, which is adapted to conform to a face of a wearer of the head-mounted device.

### BACKGROUND

A head-mounted device is a device worn by a user over his head and is used to realize an augmented reality or a virtual reality. For example, such head-mounted devices are becoming increasingly popular for playing virtual reality games and the like. Sometimes, the users may use the head-mounted device for extended duration of time, for example, to play virtual reality games continuously for hours on stretch. Therefore, it is important that the head-mounted device provides a comfortable experience for users while it is worn. However, due to the different facial contours for different users, the head-mounted device may not always achieve desired sung fit with the face of the user. Some known head-mounted devices utilize soft foam material towards the side in contact with the face of the user. However, the foam material utilized is usually a single-layered foam structure which is generally not flexible enough to properly conform to the face of the wearer, and therefore may not provide comfortable fit of the head-mounted device for the user. Further, due to loose fit, there is a possibility of light leakage into the head-mounted device while being used which may impede the experience of the user. Moreover, such single-layered foam structure is prone to wear and tear.

Therefore, there is a need of a head-mounted device having a cushion assembly which is flexible and deformable, and may be contoured to conform to a face of the wearer with ease, so as to provide comfortable experience for the user when the head-mounted device is worn.

### SUMMARY

In one aspect, a cushion assembly for a head-mounted device is provided. The cushion assembly includes a first layer molded from a foam material into a three-dimensional configuration. The cushion assembly also includes a second layer comprising at least a fabric sheet. The cushion assembly further includes a third layer comprising at least a fabric sheet. The first layer, the second layer and the third layer are molded together, with the first layer disposed between the second layer and the third layer, to define the cushion assembly adapted to conform to a face of a wearer of the head-mounted device.

Preferably, the first layer is formed by injection molding of the foam material.

Preferably, the foam material comprises one of thermoplastic rubber (TPR), thermoplastic polyurethane (TPU), silicone, ethylene vinyl acetate (EVA), polyvinyl chloride (PVC), polypropylene (PP).

Preferably, the second layer further comprises a foam sheet, and wherein the fabric sheet and the foam sheet of the second layer are molded together to define the second layer with a three-dimensional configuration complementary to the three-dimensional configuration of the first layer.

Preferably, the fabric sheet and the foam sheet of the second layer are coextensive and laminated with each other.

Preferably, the third layer further comprises a foam sheet, and wherein the fabric sheet and the foam sheet of the third layer are molded together into a three-dimensional configuration complementary to the three-dimensional configuration of the first layer.

Preferably, the fabric sheet and the foam sheet of the third layer are coextensive and laminated with each other.

Preferably, the first layer, the second layer and the third layer are joined together by ultrasonic welding.

In another aspect, a method of manufacturing a cushion assembly for a head-mounted device is provided. The method includes molding a foam material to provide a first panel with a first layer having a three-dimensional configuration defined therein. The method further includes arranging a second panel and a third panel with respect to the first panel such that the first panel is disposed between the second panel and the third panel. The method further includes molding the first panel, the second panel and the panel layer together to form a single piece laminate. The method further includes trimming the single piece laminate to form the cushion assembly adapted to conform to a face of a wearer of the head-mounted device.

Preferably, the first panel is formed by injection molding of the foam material.

Preferably, the foam material comprises one of thermoplastic rubber (TPR), thermoplastic polyurethane (TPU), silicone, ethylene vinyl acetate (EVA), polyvinyl chloride (PVC), polypropylene (PP).

Preferably, the second panel is formed by molding a fabric sheet and a foam sheet together, such that the second panel have a second layer with a three-dimensional configuration defined therein.

Preferably, the fabric sheet and the foam sheet, of the second panel, are laminated together by applying adhesive therebetween.

Preferably, the third panel is formed by molding a fabric sheet and a foam sheet together, such that the third panel have a second layer with a three-dimensional configuration defined therein.

Preferably, the fabric sheet and the foam sheet, of the third panel, are laminated together by applying adhesive therebetween.

In yet another aspect, a method of manufacturing a cushion assembly for a head-mounted device is provided. The method includes providing a foam material, in liquid form, which is to be contoured to form a first layer of the cushion assembly. The method further includes providing a fabric sheet which is to be a second layer of the cushion assembly. The method further includes providing a fabric sheet which is to be a third layer of the cushion assembly. The method further includes arranging the fabric sheet of the second layer and the fabric sheet of the third layer with respect to the foam material such that the foam material is located between the fabric sheet of the second layer and the fabric sheet of the third layer. The method further includes molding the fabric sheet of the second layer and the fabric sheet of the third layer with the foam material therebetween, to form a single piece laminate. The method further includes trimming the single piece laminate to form the cushion assembly adapted to conform to a face of a wearer of the head-mounted device.

Preferably, the first layer is formed by injection molding of the foam material.

Preferably, the method further includes providing a foam sheet laminated with the fabric sheet of the second layer.

Preferably, the method further includes providing a foam sheet laminated with the fabric sheet of the third layer.

Preferably, the method further includes joining the first layer, the second layer and the third layer by ultrasonic welding.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a more complete understanding of example embodiments of the present disclosure, reference is now made to the following descriptions taken in connection with the accompanying drawings in which:

FIG. 1 illustrates a diagrammatic perspective view of a head-mounted device incorporating a cushion assembly, in accordance with one or more embodiments of the present disclosure;

FIG. 2 illustrates a diagrammatic perspective view of the cushion assembly, in accordance with one or more embodiments of the present disclosure;

FIG. 3A illustrates a diagrammatic view of a molding setup for defining a first layer of the cushion assembly, in accordance with one or more embodiments of the present disclosure;

FIG. 3B illustrates a diagrammatic perspective view of a first panel having the first layer of the cushion assembly defined therein, in accordance with one or more embodiments of the present disclosure;

FIG. 4A illustrates a diagrammatic view of a molding setup for defining a second layer of the cushion assembly, in accordance with one or more embodiments of the present disclosure;

FIG. 4B illustrates a diagrammatic perspective view of a second panel having the second layer of the cushion assembly defined therein, in accordance with one or more embodiments of the present disclosure;

FIG. 5A illustrates a diagrammatic view of a molding setup for defining a third layer of the cushion assembly, in accordance with one or more embodiments of the present disclosure;

FIG. 5B illustrates a diagrammatic perspective view of a third panel having the third layer of the cushion assembly defined therein, in accordance with one or more embodiments of the present disclosure;

FIG. 6A illustrates a diagrammatic view of a molding setup for molding the first layer, the second layer and the third layer together for defining the cushion assembly, in accordance with one or more embodiments of the present disclosure;

FIG. 6B illustrates a diagrammatic perspective view of a single piece laminate having the cushion assembly defined therein, in accordance with one or more embodiments of the present disclosure;

FIG. 7A illustrates a diagrammatic perspective view of the cushion assembly, in accordance with one or more embodiments of the present disclosure;

FIG. 7B illustrates a diagrammatic front view of the cushion assembly, in accordance with one or more embodiments of the present disclosure;

FIG. 7C illustrates a diagrammatic rear view of the cushion assembly, in accordance with one or more embodiments of the present disclosure; and

FIG. 8 illustrates a diagrammatic view depicting assembling of the head-mounted device with a main body and the cushion assembly separated from each other, in accordance with one or more embodiments of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, apparatuses and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments.

The embodiments are described herein for illustrative purposes and are subject to many variations. It is understood that various omissions and substitutions of equivalents are contemplated as circumstances may suggest or render expedient, but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

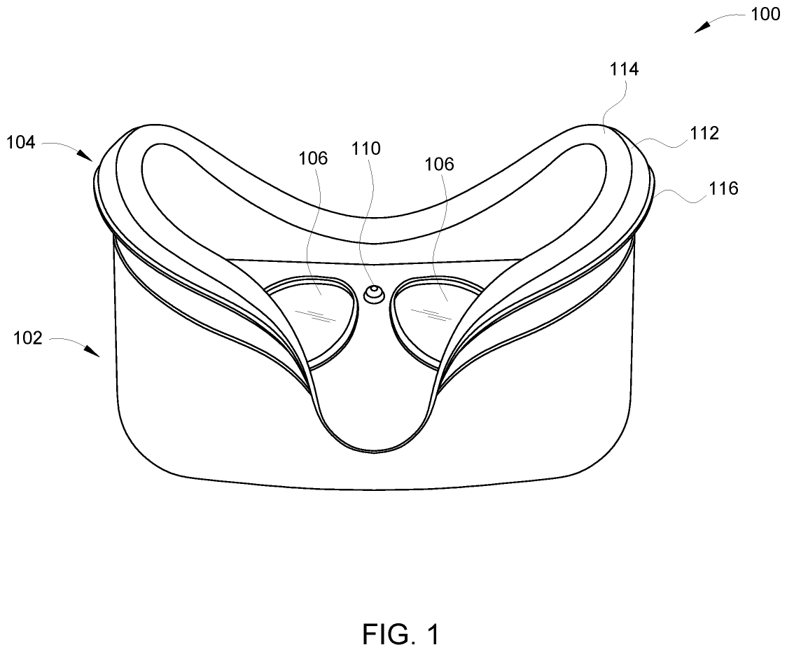

Referring to the drawings, FIG. 1 illustrates a head-mounted device 100 (hereinafter simply referred to as “device 100”), in accordance with an embodiment of the present disclosure. The device 100 is a wearable device which is worn on the human head to provide the wearer a personal viewing experience. As illustrated in FIG. 1, the device 100 of the present embodiment is, for example, an eye mask type wearable device, which is worn by the user on his/her face around the eyes to view displayed images. The device 100 may be configured for producing virtual reality (VR), augmented reality (AR), and stereoscopic experiences, such as three dimensional (3D) and 360° movies and games.

As illustrated in FIG. 1, the device 100 generally includes a main body 102 and a cushion assembly 104. In the device 100, the cushion assembly 104 is disposed between the main body 102 and the head of the user, when the device 100 is worn. That is, the cushion assembly 104 is disposed closer to the face of the user wearing the device 100 as compared to the main body 102 thereof. The main body 102 may be molded into a goggle shape. In one example, the main body 102 may be made of plastic material or the like. The main body 102 may accommodate components with various suitable functions. For example, the main body 102 may include a display unit (not shown) for displaying the image. The display unit may be integrally formed in the main body 102, or may be in the form of a removable mobile computing device, such as a smartphone, which may be inserted into the main body 102 during operation of the device 100. Further, the main body 102 may accommodate two lenses 106 configured to focus vision of the user on selected areas of the display unit, when the device 100 is worn.

In one or more examples, the main body 102 may also accommodate an acceleration sensor (not shown) which senses a movement of the user wearing the device 100 and applies a signal to the display unit to display an image corresponding to a change in the user's eye movement. In addition, the main body 102 may also include controls (not shown) generally provided on an outer portion thereof, to control a volume or a brightness of the display unit. The controls may be in the form of a physical button or a touch sensor without any limitations. The main body 102 may further include components, such as, but not limited to, proximity sensor, speakers, Bluetooth module, Wi-Fi module, etc. to enhance the experience of the user wearing the device 100. In some examples, a strap (not shown) may be used to securely attach the device 100 to the head of the user; however, other or additional means and methods may be used, such as various items and techniques that are readily available for other goggles and glasses type products which may be applied to the main body 102. For example, the main body 102 may be incorporated into a helmet-like device which is secured to the top of the head without a strap.

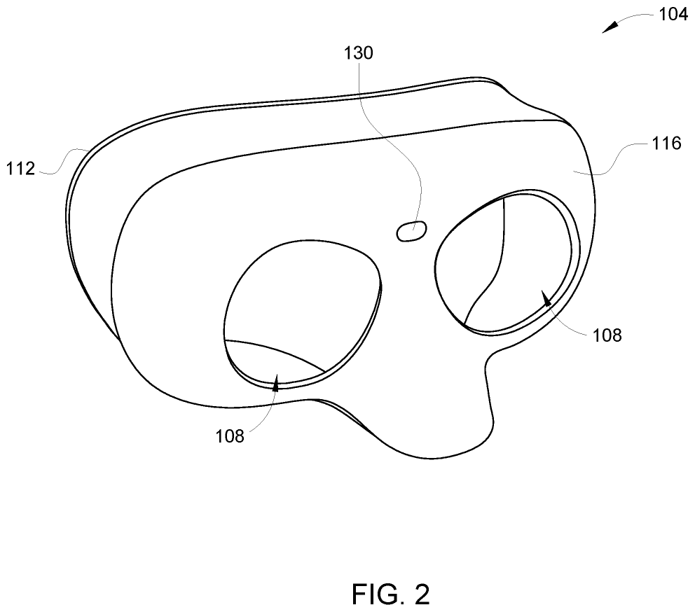

FIG. 2 illustrates a perspective view of the cushion assembly 104, in accordance with an embodiment of the present disclosure. In an embodiment, the cushion assembly 104 may be formed separately from the main body 102, and later coupled to the main body 102 (as will be discussed later). The cushion assembly 104 generally have a three-dimensional shape conforming to a shape of human head at least from one side thereof. In some examples, the cushion assembly 104 is designed to generally conform to temple region and nasal region of the face of the wearer of the device 100. As illustrated in FIG. 2, the cushion assembly 104 further provides openings 108 formed therein. Referring to FIGS. 1-2 in combination, it may be seen that the openings 108 are formed such that the openings 108 line up with the two lenses 106 of the main body 102, when the cushion assembly 104 and the main body 102 are assembled together to complete the device 100. Accordingly, when the user may wear the device 100 with the cushion assembly 104 sitting on the face of the user, the user may be able to see, via the openings 108, the image(s) being formed on the lenses 106 in the main body 102.

The cushion assembly 104 of the present disclosure is a multi-layer structure. According to an embodiment, as illustrated in FIGS. 1-2, the cushion assembly 104 includes three layers, a first layer 112, a second layer 114 (not visible in FIG. 2) and a third layer 116. As may be seen, the first layer 112 is disposed between the second layer 114 and the third layer 116, in the cushion assembly 104. The three layers 112, 114, 116 are arranged such that the second layer 114 forms a rear of the cushion assembly 104 and is in contact with the face of the user when the device 100 is worn. In an embodiment of the present disclosure, the three layers 112, 114, 116 are molded together using known heat molding techniques involving the application of heat and pressure to form the cushion assembly 104. In one or more examples, the three layers 112, 114, 116 may be bonded or laminated during the molding process simply by the application of heat and pressure, or may additionally involve the use of an adhesive to facilitate bonding of the layers. The employed bonding techniques may depend largely on the nature of the various layers, e.g. leather, fabric, foam, etc. In one embodiment of the present disclosure, the first layer 112, the second layer 114 and the third layer 116 are separately pre-molded and later joined together to form the cushion assembly 104. The following paragraphs explain in detail the molding setups and processes for forming the first layer 112, the second layer 114 and the third layer 116 individually, and further the molding setup and process for joining the three layers 112, 114, 116 together to form the cushion assembly 104.

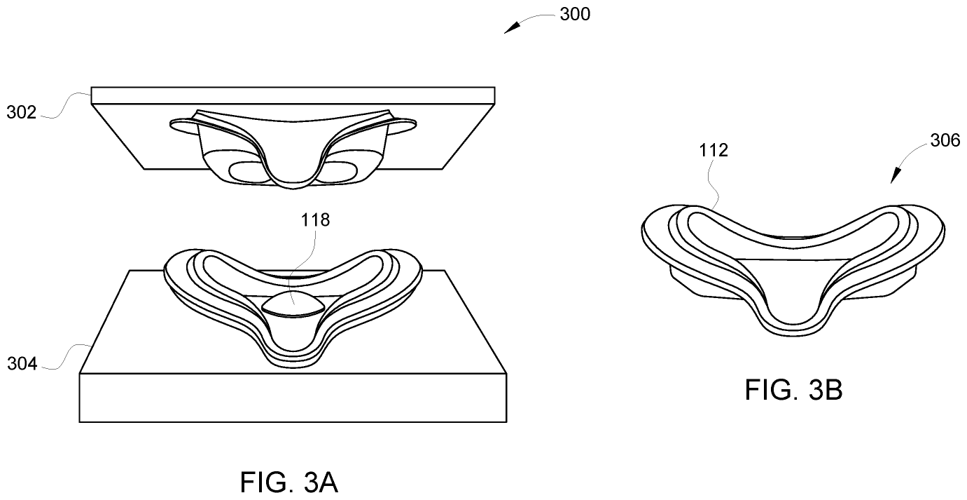

FIG. 3A illustrates a molding setup 300 for forming the first layer 112 of the cushion assembly 104. As illustrated, the molding setup 300 includes a first molding part 302 and a second molding part 304. In an embodiment, the first layer 112 is formed of a foam material 118. The foam material 118 is preferably a polyurethane foam. In other examples, the foam material 118 may be any one of thermoplastic rubber (TPR), thermoplastic polyurethane (TPU), silicone, ethylene vinyl acetate (EVA), polyvinyl chloride (PVC), polypropylene (PP), etc. In an embodiment, the first layer 112 is formed by injection molding of the foam material 118. For this purpose, the foam material 118 in liquid form, and in appropriate quantity, is injected into a cavity between the first molding part 302 and the second molding part 304. The injection molding of the foam material 118 forms a first panel 306 (as illustrated in FIG. 3B) with the first layer 112 having a three-dimensional configuration defined therein. The injection molding process of foam materials is well known in the art and thus have not been described herein for the brevity of the present disclosure.

In other examples, the molding process may involve compression molding the foam material 118 to define the first layer 112. In such case, the form material 118, in liquid form, and in appropriate quantity, is placed in the form of a semi-spherical blob in the second molding part 304 (as illustrated in FIG. 3A). Thereafter, the molding process involves pressing the foam material 118 between the convex molding part 302 and the concave molding part 304 under heat and pressure, to form the first panel 306 (as illustrated in FIG. 3B) with the first layer 112 having a three-dimensional configuration defined therein. It may be seen from FIG. 3B that the first layer 112 forms a part of the first panel 306 and may be obtained by trimming the edges of the first panel 306 (as discussed later). In one example, the thickness of the first panel 306 formed by the present molding process is the range of about 4-8 mm, and preferably 6 mm; however, it may be appreciated that the given dimensions are exemplary only and shall not be construed as limiting to the present disclosure.

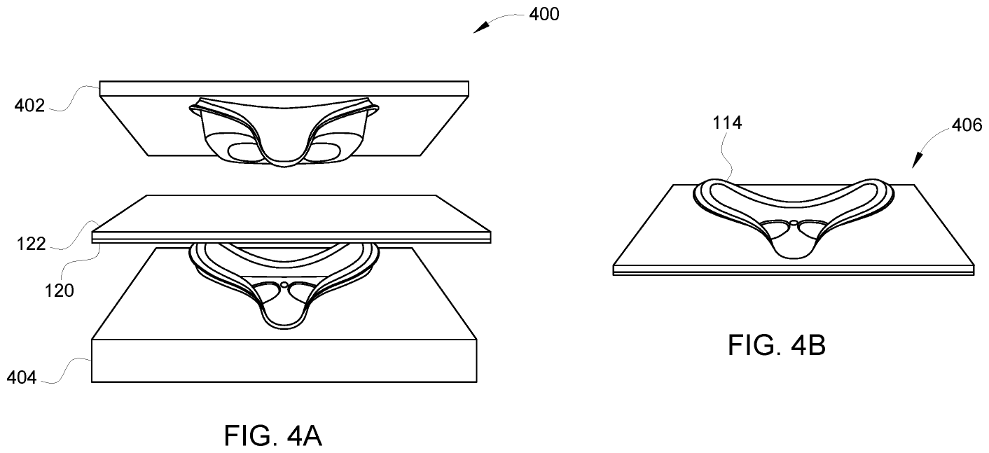

FIG. 4A illustrates a molding setup 400 for forming the second layer 114 of the cushion assembly 104. In an embodiment, the second layer 114 includes a fabric sheet 120 and a foam sheet 122 stacked onto and joined with each other. In one example, the fabric sheet 120 may have a thickness of about 1-2 mm, and preferably 1.7 mm; and the foam sheet 122 may have a thickness of about 2-4 mm, and preferably 3.1 mm; however, it may be appreciated that the given dimensions are exemplary only and shall not be construed as limiting to the present disclosure. Further, the fabric sheet 120 and the foam sheet 122 of the second layer 114 are coextensive and laminated with each other. In one example, the second layer 114 includes adhesive applied between the fabric sheet 120 and the foam sheet 122 to facilitate the lamination thereof. In one example, the fabric sheet 120 may be a product known by model number CMF-7440MU of Friendly Foundate Ltd. and having a make-up of approximately 80% Tactel and 20% Lycra, and of a weight of, for example, about 190 g/sqm. Further, the foam sheet 122 is preferably of a polyurethane foam such as, for example, EL58-4S of Inoac Corporation which is a memory foam. In some examples, the fabric sheet 120 and the foam sheet 122 may be laminated together using an adhesive, such as glue HM-1 of Forbo Swift Adhesives SA. The adhesive may be sprayed onto at least one of the opposing facing surfaces of the fabric sheet 120 and the foam sheet 122, of the second layer 114. The adhesive may stick the fabric sheet 120 and the foam sheet 122 together when dry without heating.

Further, as illustrated in FIG. 4A, the molding setup 400 includes a first molding part 402 and a second molding part 404. In one example, the molding process for forming the second layer 114 may involve compression molding the laminate of the fabric sheet 120 and the foam sheet 122 between the convex molding part 402 and the concave molding part 404 to form a second panel 406 (as illustrated in FIG. 4B) with the second layer 114 having a three-dimensional configuration defined therein. It may be seen from FIG. 4B that the second layer 114 forms a part of the second panel 406 and may be obtained by trimming the edges of the second panel 406 (as discussed later). In one or more examples, the molding process for forming the second panel 406 is carried under heat and pressure. In one example, the molding parts 402, 404 may be carried out at a temperature in the range of about 180° C. to 200° C. Further, the dwell time for holding the molding parts 402, 404 together, in order to properly press the laminate of the fabric sheet 120 and the foam sheet 122, is about 120 seconds.

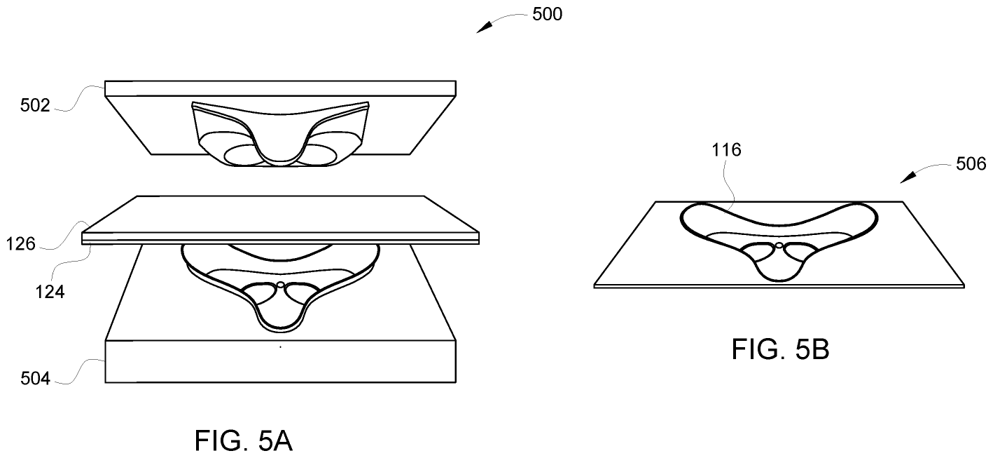

FIG. 5A illustrates a molding setup 500 for forming the third layer 116 of the cushion assembly 104. In an embodiment, the third layer 116 includes a fabric sheet 124 and a foam sheet 126 stacked onto and joined with each other. The material and structural properties of the fabric sheet 124 and the foam sheet 126 of the third layer 116 may substantially be similar to the fabric sheet 120 and the foam sheet 122, respectively, of the second layer 114. As illustrated in FIG. 5A, the molding setup 500 includes a first molding part 502 and a second molding part 504. The molding process for forming the third layer 116 may involve compression molding the laminate of the fabric sheet 124 and the foam sheet 126 between the convex molding part 502 and the concave molding part 504 to form a third panel 506 (as illustrated in FIG. 5B) with the third layer 116 having a three-dimensional configuration defined therein. It may be seen from FIG. 5B that the third layer 116 forms a part of the third panel 506 and may be obtained by trimming the edges of the third panel 506 (as discussed later). In one or more examples, the molding process for forming the third panel 506 is carried under heat and pressure. In one example, the molding parts 502, 504 may be at a temperature in the range of about 180° C. to 200° C., similar to the molding process for the second layer 114. Further, the dwell time for holding the molding parts 502, 504 together may be, for example, about 120 seconds, similar to the molding process for the second layer 114.

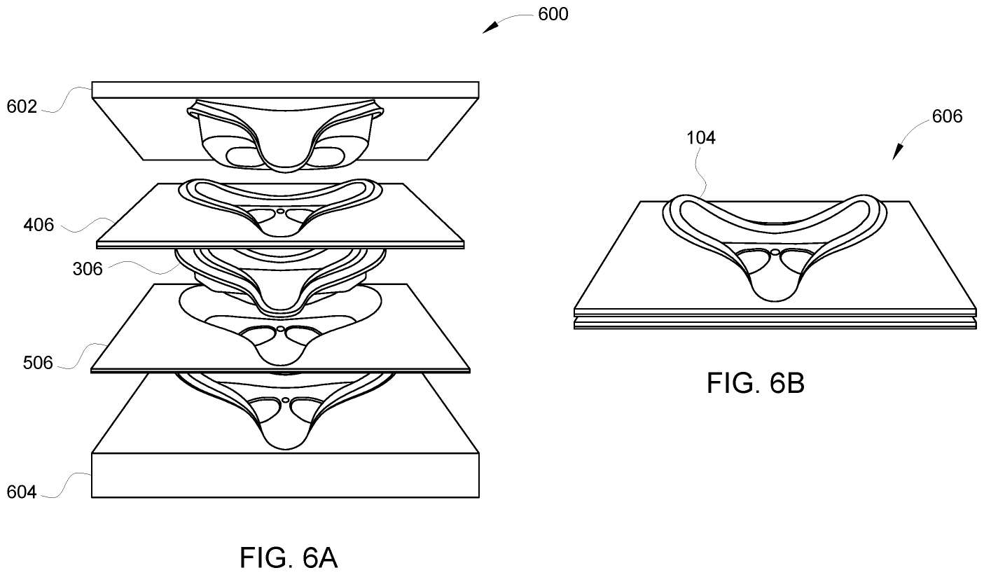

FIG. 6A illustrates a molding setup 600 for molding the first layer 112, the second layer 114 and the third layer 116 together. As illustrated in FIG. 6A, the molding setup 600 includes a first molding part 602 and a second molding part 604. In particular, the molding process carried by the molding setup 600 involves the molding of the first panel 306, the second panel 406 and the third panel 506 together. The molding process takes place by arranging the second panel 406 and the third panel 506 with respect to the first panel 306 such that the first panel 306 is disposed between the second panel 406 and the third panel 506. In the present embodiment, the second panel 406 and the third panel 506 may be arranged such that the corresponding foam sheets 122 and 126 may be facing and are joined with the first panel 306 during the molding process. That is, the fabric sheet 120 and the fabric sheet 124 of the second layer 114 and the third layer 116, respectively, are arranged so as to be part of the exterior surface of the cushion assembly 104 as formed by the molding process being carried out in the molding setup 600.

In the molding process, the three panels 306, 406, 506 are pressed together using the first molding part 602 and the second molding part 604. In some examples, the surfaces of the first layer 112, facing the second layer 114 and the third layer 116, may be provided with adhesive to join the first layer 112, the second layer 114 and the third layer 116 together. In one example, the adhesive may be a glue such as RM-30 of Ultra Energy Adhesive Trading Co., Ltd. The adhesive may be sprayed on the surfaces of the first layer 112 and the corresponding facing surfaces of the second layer 114 and the third layer 116. The molding process may involve use of heat and pressure for joining together the three panels 306, 406, 506, and further aid with drying of the adhesive glue. For example, this adhesive may not get dry and sticky until heated, but then stick to join the three panels 306, 406, 506 when heated during the molding process. The molding process of FIG. 6A results in forming of a single piece laminate 606 (as illustrated in FIG. 6B).

It may be contemplated that the thickness of the cushion assembly 104 is generally based on the combined thickness of the first panel 306, the second panel 406 and the third panel 506. In some cases, it may be desired that the thickness of the cushion assembly 104 could be more than the combined thickness, i.e. in comparison to the single piece laminate 606 formed by molding the first panel 306, the second panel 406 and the third panel 506 together. This may be desired for various reasons, such as, but not limited to, make the cushion assembly 104 generally conform to certain anatomical features of the human head. For this purpose, in some examples, additional padding may be provided between one or more of the first layer 112 and the second layer 114, and the first layer 112 and the third layer 116, at regions corresponding to anatomically determined positions. This additional padding may include, for example, one or more thick foam inserts (not shown) positioned between the first layer 112, and the second layer 114 and/or the third layer 116. These inserts may further be incorporated to provide additional support and reinforcement in areas which are subject to additional wear and tear in the cushion assembly 104.

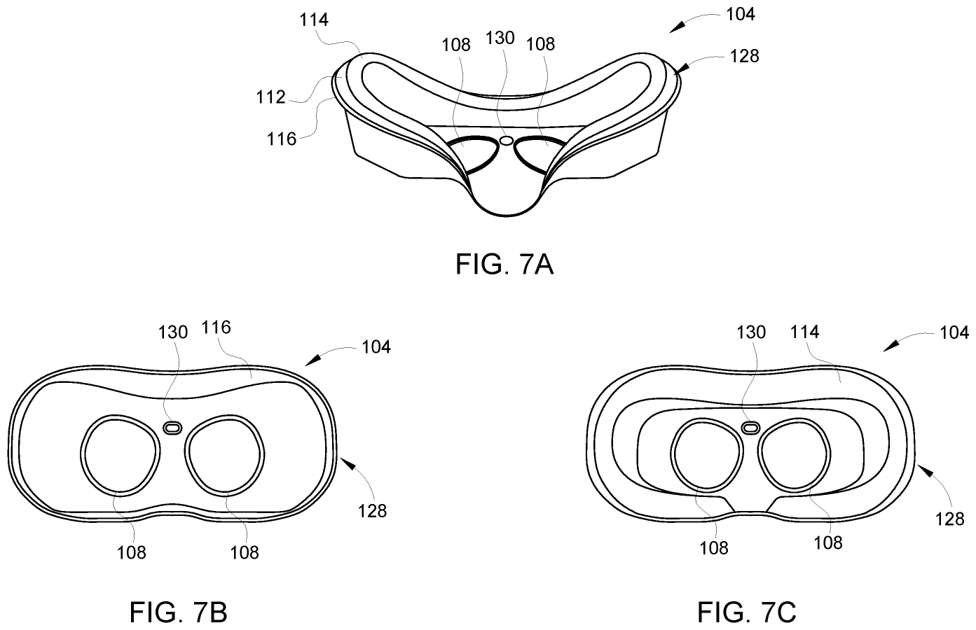

As noted above, the single piece laminate 606 may generally have the cushion assembly 104 molded to the appropriate form therein. In one embodiment, the cushion assembly 104 is trimmed out from the single piece laminate 606 to assume a form as, for example, illustrated in FIGS. 7A-7C. Such trimming may be carried out manually or may be done ultrasonically by an ultrasonic machine (not shown) such as device EGR-053 of Ever Green Ultrasonic Co., Ltd. In some examples, the trimming procedure may further involve the use of a trimming roller (not shown). The ultrasonic trimming machine may cut edges of the single piece laminate 606 so as to extricate the cushion assembly 104 therefrom. In some examples, the ultrasonic trimming machine may further be configured to bond the corresponding edges of the first layer 112, the second layer 114 and the third layer 116 together by ultrasonic welding at the same time, to provide the cushion assembly 104 of the present disclosure. In alternative examples, the single piece laminate 606 may be trimmed by laser cutting, and further edges of the first layer 112, the second layer 114 and the third layer 116 may be joined together by laser welding, without any limitations.

Different views of the finished cushion assembly 104 are shown in FIGS. 7A-7C. Referring to the drawings, it may be seen that the first layer 112, the second layer 114 and the third layer 116 may be joined together at an edge 128 of the cushion assembly 104. As discussed, in one example, the edge 128 may be finished by ultrasonically trimming the single piece laminate 606 and ultrasonically welding the resultant first layer 112, the second layer 114 and the third layer 116 together. Alternatively, the first layer 112, the second layer 114 and the third layer 116 may be finished by folding the second layer 114 over a peripheral edge (not shown) of the third layer 116 to cover and envelop the first layer 112 therebetween. Adhesive, such as, a double sided adhesive tape (not shown) may be provided on the underside of the overlapping second layer 114 to be secured with the peripheral edge of the third layer 116 by heat pressing technique or the like.

As described in the preceding paragraphs, the first layer 112, the second layer 114 and the third layer 116 of the cushion assembly 104 may be molded into corresponding three-dimensional configuration and then the molded pieces are joined together, for example, by ultrasonic welding or other non-stitching means. It may be understood that the second layer 114 and the third layer 116 may be pre-molded into respective three-dimensional configurations which are complimentary to the three-dimensional configuration of the first layer 112. The ultrasonic welding step may optionally be followed by application of a heat pressed adhesive strip (not shown) to cover and protect the edge 128 of the cushion assembly 104, in order to provide a seamless feel to the wearer.

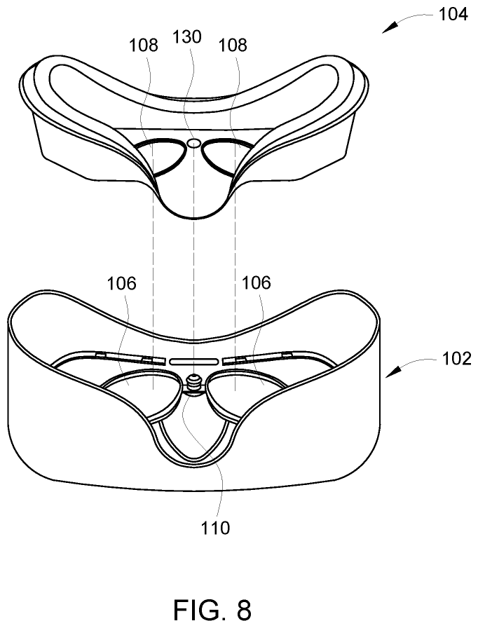

In one or more examples, the trimming process may further include forming the apertures and openings in the cushion assembly 104 for various purposes. For example, the openings 108 may be formed in the cushion assembly 104 by using the same ultrasonic cutting machine (as discussed before). The openings 108 may be dimensioned and positioned in the cushion assembly 104 as per the requirement. In one example, the cushion assembly 104 may further provide an aperture 130 formed therein substantially in the middle along a longitudinal axis thereof. The aperture 130 may be utilized for connecting and integrating the cushion assembly 104 with the main body 102 to complete the device 100. FIG. 8 illustrates the positioning of the cushion assembly 104 with respect to the main body 102, for carrying the integration thereof. As may be seen, the cushion assembly 104 may be inserted into the main body 102 with the aperture 130 aligned with a protrusion 110 in the main body 102. The protrusion 110 may get stuck in the aperture 130 due to flexible nature of the cushion assembly 104, thereby securing the cushion assembly 104 with the main body 102 (as seen in FIG. 1).

It may be appreciated that the molding process for forming the cushion assembly 104 may be carried out in different manners, in addition to the one described above. In alternate examples, the second layer 114 may include the fabric sheet 120 only, and not the foam sheet 122. Similarly, the third layer 116 may include the fabric sheet 124 only, and not the foam sheet 126. In other examples, the second layer 114 and the third layer 116 may not necessarily be pre-molded into the corresponding second panel 406 and the third panel 506, respectively; but are arranged in the molding setup 600 directly as the laminates (or the fabric sheets) for molding along with the first layer 112 to form the cushion assembly 104. In other alternative examples, the first layer 112 may not necessarily be pre-molded into the corresponding first panel 306; but the foam material 118, in liquid form, may be placed directly between the laminates (or the fabric sheets) of the second layer 114 and the third layer 116 in the molding setup 600, in order to form the cushion assembly 104.

In one or more embodiments of the present disclosure, the first layer 112 may include a plurality of apertures (not shown) formed therein. In one or more examples, some of the plurality of apertures may have a truncated conical cross-section with a relatively larger diameter towards an inner side (i.e. the side in contact with the second layer 114) of the first layer 112 and a relatively smaller diameter towards the outer side (i.e. the side in contact with the third layer 116) of the first layer 112. Further, in one or more examples, some of the plurality of apertures are elongated apertures. These elongated apertures may have a dumbbell shape with a slit and two openings formed at two ends of the slits respectively, such that each of the one or more of the plurality of elongated apertures allows for expansion of the first layer along a direction substantially orthogonal to a direction of extension of the corresponding slit therein, while the said openings allow for ventilation therein. Furthermore, in one or more examples, the first layer 112 may have protrusions (not shown) defined therein at the said inner side (i.e. the side in contact with the second layer 114). The protrusions may be arranged in a matrix form such that one or more of the plurality of apertures are surrounded by three or more protrusions at the inner side (i.e. the side in contact with the second layer 114) of the first layer.

The cushion assembly 104 of the present disclosure with multi-layer structure provides higher deformability, especially to flex inward for smaller heads and spread apart for larger heads, as compared to cushion structures for headsets with a single thin foam layer as conventionally known in the art. Furthermore, due to the expansive design of the cushion assembly 104, the third layer 116 may sit on the main body 102 which may provide higher flexibility for the cushion assembly 104 with respect to adjustment against the main body 102. This may allow for a snug fit for a large range of head sizes, providing a one-size-fits-all solution. The cushion assembly 104 being, primarily, formed from foam material and generally light fabric sheets may be light-weight in comparison to conventional cushion structures using plastic or metal frame, or the like. In addition, the present flexible structure may also provide comfort to the user wearing the device 100, since the cushion assembly 104 may easily adapt to varying facial shapes of the users. The present cushion assembly 104 further evenly distributes pressure caused by the weight of the device 100 to the face of the user, thereby further providing comfort during long use.

The construction of the present device 100 is simplified by the fact that the cushion assembly 104 is a single piece assembly of layers. Molding of the cushion assembly 104 may substantially simplify the otherwise complicated process of stitching various layers together. The cushion assembly 104 may be manufactured substantially without or with no significant stitching. This may result in significant savings in labor cost which may otherwise be needed for manual stitching of the various layers together. The implementation of injection molding for forming the first layer 112 results in even distribution of the foam material 118 in the first layer 112 between thin and thick sections of the cushion assembly 104. This even density distribution of the foam material 118 in the first layer 112 may generally result in stability of the overall structure of the device 100. This further enhances the ability of the cushion assembly 104 to absorb impacts, including torsional and compressive forces to the device 100. The fabric sheets 120, 124 of the second layer 114 and the third layer 116, which form the exterior surface of the cushion assembly 104, may provide breathable material in contact with the face of the user, when the device 100 is worn. This may help to absorb and disperse moisture from the skin to some extent, thereby providing further comfort for the user wearing the device 100. The fabric sheets 120, 124 may further be formulated with anti-microbial chemicals, which may improve hygiene conditions due to prolong use of the device 100.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

What is claimed is:

1. A cushion assembly for a head-mounted device, the cushion assembly comprising:
a first layer molded from a foam material into a three-dimensional configuration;
a second layer comprising at least a fabric sheet; and
a third layer comprising at least a fabric sheet,
wherein the first layer, the second layer and the third layer are molded together, with the first layer disposed between the second layer and the third layer, to define the cushion assembly adapted to conform to a face of a wearer of the head-mounted device.

2. The cushion assembly as claimed in claim 1, wherein the first layer is formed by injection molding of the foam material.

3. The cushion assembly as claimed in claim 1, wherein the foam material comprises one of thermoplastic rubber (TPR), thermoplastic polyurethane (TPU), silicone, ethylene vinyl acetate (EVA), polyvinyl chloride (PVC), polypropylene (PP).

4. The cushion assembly as claimed in claim 1, wherein the second layer further comprises a foam sheet, and wherein the fabric sheet and the foam sheet of the second layer are molded together to define the second layer with a three-dimensional configuration complementary to the three-dimensional configuration of the first layer.

5. The cushion assembly as claimed in claim 4, wherein the fabric sheet and the foam sheet of the second layer are coextensive and laminated with each other.

6. The cushion assembly as claimed in claim 1, wherein the third layer further comprises a foam sheet, and wherein the fabric sheet and the foam sheet of the third layer are molded together into a three-dimensional configuration complementary to the three-dimensional configuration of the first layer.

7. The cushion assembly as claimed in claim 6, wherein the fabric sheet and the foam sheet of the third layer are coextensive and laminated with each other.

8. The cushion assembly as claimed in claim 1, wherein the first layer, the second layer and the third layer are joined together by ultrasonic welding.

9. A method of manufacturing a cushion assembly for a head-mounted device, the method comprising:
molding a foam material to provide a first panel with a first layer having a three-dimensional configuration defined therein;
arranging a second panel and a third panel with respect to the first panel such that the first panel is disposed between the second panel and the third panel;
molding the first panel, the second panel and the panel layer together to form a single piece laminate; and
trimming the single piece laminate to form the cushion assembly adapted to conform to a face of a wearer of the head-mounted device.

10. The method as claimed in claim 9, wherein the first panel is formed by injection molding of the foam material.

11. The method as claimed in claim 9, wherein the foam material comprises one of thermoplastic rubber (TPR), thermoplastic polyurethane (TPU), silicone, ethylene vinyl acetate (EVA), polyvinyl chloride (PVC), polypropylene (PP).

12. The method as claimed in claim 9, wherein the second panel is formed by molding a fabric sheet and a foam sheet together, such that the second panel have a second layer with a three-dimensional configuration defined therein.

13. The method as claimed in claim 12, wherein the fabric sheet and the foam sheet, of the second panel, are laminated together by applying adhesive therebetween.

14. The method as claimed in claim 9, wherein the third panel is formed by molding a fabric sheet and a foam sheet together, such that the third panel have a second layer with a three-dimensional configuration defined therein.

15. The method as claimed in claim 14, wherein the fabric sheet and the foam sheet, of the third panel, are laminated together by applying adhesive therebetween.

16. A method of manufacturing a cushion assembly for a head-mounted device, the method comprising:
providing a foam material, in liquid form, which is to be contoured to form a first layer of the cushion assembly;
providing a fabric sheet which is to be a second layer of the cushion assembly;
providing a fabric sheet which is to be a third layer of the cushion assembly;
arranging the fabric sheet of the second layer and the fabric sheet of the third layer with respect to the foam material such that the foam material is located between the fabric sheet of the second layer and the fabric sheet of the third layer;
molding the fabric sheet of the second layer and the fabric sheet of the third layer with the foam material therebetween, to form a single piece laminate; and
trimming the single piece laminate to form the cushion assembly adapted to conform to a face of a wearer of the head-mounted device.

17. The method as claimed in claim 16, wherein the first layer is formed by injection molding of the foam material.

18. The method as claimed in claim 16 further comprising providing a foam sheet laminated with the fabric sheet of the second layer.

19. The method as claimed in claim 16 further comprising providing a foam sheet laminated with the fabric sheet of the third layer.

20. The method as claimed in claim 17 further comprising joining the first layer, the second layer and the third layer by ultrasonic welding.
